(19) United States
(12) Patent Application Publication
(10) Pub. No.: US 2018/0283093 A1
(43) Pub. Date: Oct. 4, 2018

(54) ACCESSORY OF VENETIAN BLIND

(71) Applicants: William Wei-Loon Tseng, Millbrae, CA (US); Peng-Chin Wu, Changhua County (TW)

(72) Inventors: William Wei-Loon Tseng, Millbrae, CA (US); Peng-Chin Wu, Changhua County (TW)

(21) Appl. No.: 15/937,890

(22) Filed: Mar. 28, 2018

Related U.S. Application Data
(60) Provisional application No. 62/478,032, filed on Mar. 28, 2017.

(30) Foreign Application Priority Data
Sep. 22, 2017 (TW) 106214121

(51) Int. Cl. E06B 9/323; A47H 2/00

(52) U.S. Cl. CPC E06B 9/323; A47H 2/00

(57) ABSTRACT

A fixing device includes a main body; a first coupling member disposed on the main body for coupling to the upper rail; a second coupling member disposed on the main body for coupling to the cover plate. The second coupling member includes an engagement projection, which includes a base fitted into and slidable inside a slide groove. The slide groove is disposed on a surface of the main body facing the cover plate. The second coupling member further includes a bump protruding from the base and inserted into a groove in the slide groove, and the bump is movable between grooves along a first direction. The bump can move in the groove in a first direction and is stopped from moving in a second direction opposite to the first direction. Two ends of the engagement projection are different in configuration to specify the first direction.

### FIELD OF THE INVENTION

The present invention relates to an accessory of a mechanical assembly, and more particularly to an accessory of mechanical assembly for use with a venetian blind.

### BACKGROUND OF THE INVENTION

A venetian blind is a common curtain design, and its appearance is shown in FIG. 1. There are blades 11 and an upper rail 1, and the upper rail 1 is used for accommodating the ladder belt 12 and the related lifting device (not shown in the figure) required for lifting the blades 11. However, since the main :function of the upper rail 1 is to accommodate a lifting device, it is mostly of a monotonous shape and a basic color. Nowadays, interior decoration has a main demand on aesthetics, and therefore a cover plate 13 (as shown in FIG. 2) is additionally mounted to cover the upper rail 1. As a result, the appearance and design of the cover plate 13 can vary with the aesthetic requirements of the interior decoration.

Conventionally, the cover plate 13 is fixed on a wall where the venetian blind is to be mounted to cover the upper rail 1. The positions of the upper rail 1 on the wall might vary with allocation of window frames and other designs. Therefore, modification is required case by case, resulting in difficulty in construction and inflexibility in use.

### SUMMARY OF THE INVENTION

Therefore, it is desirable to develop a fixing mechanism which secures the cover plate to the upper rail of the venetian blind instead of to the wall. Preferably, the cover plate can be easily mounted to and detached from the upper rail so as to simplify the construction process.

An object of the present invention is to provide a fixing device of a mechanical assembly, which not only connects two parts of the assembly together but also allows the two parts of the assembly to move relative to each other for positional adjustment. When the mechanical assembly is a venetian blind, the two parts are an upper rail and a cover plate for covering the upper rail.

The present invention also provides a mechanical assembly assembled through a fixing device as described above.

In an aspect of the present invention, a mechanical assembly comprises a steady body; a detachable member mounted onto the steady body; and a fixing device including a main body, a first coupling member disposed on the main body for coupling to the steady body and a second coupling member disposed on the main body for coupling to the detachable member, at least one of the first and second coupling members being detachable from the stead body and/or the detachable member so as to have the detachable member detachable from the steady body. The second coupling member includes an engagement projection, which includes a base fitted into a slide groove of the main body, and a wedge bump protruding from the base and inserted into and engaged with a specified one of a plurality of wedge grooves in the slide groove. The wedge bump is movable from the specified wedge groove into next wedge groove along a first direction in response to a force for adjusting a relative position of the detachable member to the steady body. The specified wedge groove has a slope wall which facilitates the wedge bump to move in the first direction and a flat wall which stops the wedge bump from moving in a second direction opposite to the first direction, and a first end and a second end of the engagement projection are different in configuration in order to specify the first direction. In an embodiment, the stead body is an upper rail of a venetian blind, and the detachable member is a cover plate of the venetian blind.

In an embodiment, the first coupling member includes a hook that hangs on a top edge of the upper rail. In another embodiment, the first coupling member includes a magnet that is attached onto the upper rail and an optional stopper above the magnet for positioning the fixing device relative to the upper rail.

In an embodiment, the second coupling member includes the engagement projection, the cover plate has an engagement track on a back surface thereof, and the engagement track includes an upper groove and a lower groove at opposite sides of an opening of the engagement track so as to result in an accommodating space for accommodating the engagement projection therein. The engagement projection has a longer side having a length greater than a width of the opening of the engagement track, and a shorter side having a length smaller than the width of the opening of the engagement track, and the engagement track has an upper groove and a lower groove so as to result in a width of the accommodating space greater than the width of the opening and the length of the longer side of the engagement projection, thereby allowing the engagement projection to be inserted into the engagement track with the shorter side, and allowing the longer side to enter the upper groove and the lower groove and stopped from escaping from the engagement track after turning the engagement projection. In an alternative embodiment, the engagement projection includes two free ends which are different in shapes and spaced from each other with a slot so that the two free ends transformable to enter the engagement track from the opening and restorable to be stuck in the upper groove and the lower groove to be stopped from escaping from the engagement track. in a more specific embodiment, one of the two ends of the engagement projection has a plurality of continuous tangent surfaces.

Preferably, the engagement projection is added with an irritating flavor. For example, the irritating flavor is a bitter flavor of denatonium benzoate.

In another aspect of the present invention, a mechanical assembly comprises: a steady body; a detachable member mounted onto the steady body; and a fixing device including a main body, a first coupling member disposed on the main body for coupling to the steady body and a second coupling member disposed on the main body for coupling to the detachable member, at least one of the first and second coupling members being detachable from the stead body and/or the detachable member so as to have the detachable member detachable from the steady body. The second coupling member includes an engagement projection, which includes a base fitted into and slidable inside a slide groove. The slide groove is disposed on a surface of the main body facing the detachable member. The second coupling member further includes a wedge bump protruding from the base and inserted into and engaged with a specified one of a plurality of wedge grooves in the slide groove. The wedge bump is movable from the specified wedge groove into next wedge groove along a first direction in response to a force for adjusting a relative position of the detachable member to the steady body. The specified wedge groove has a slope wall which facilitates the wedge bump to move in the first direction and a flat wall which stops the wedge bump from moving in a second direction opposite to the first direction.

In a further aspect of the present invention, a fixing device for detachably mounting a cover plate to an upper rail for assembling a venetian blind, comprises a main body; a first coupling member disposed on the main body for coupling to the upper rail; a second coupling member disposed on the main body for coupling to the cover plate. At least one of the first and second coupling members is detachable from the upper rail and/or the cover plate so as to have the cover plate detachable from the upper rail. The second coupling member includes an engagement projection, which includes a base fitted into and slidable inside a slide groove. The slide groove is disposed on a surface of the main body facing the cover plate. The second coupling member further includes a wedge bump protruding from the base and inserted into and engaged with a specified one of a plurality of wedge grooves in the slide groove, and the wedge bump is movable from the specified wedge groove into next wedge groove along a first direction in response to a force for adjusting a relative position of the cover plate to the upper rail. The specified wedge groove has a slope wall which facilitates the wedge bump to move in the first direction and a flat wall which stops the wedge bump from moving in a second direction opposite to the first direction, and a first end and a second end of the engagement projection are different in configuration in order to specify the first direction.

### BRIEF DESCRIPTION OF THE DRAWINGS

The above contents of the present invention will become more readily apparent to those ordinarily skilled in the art after reviewing the following detailed description and accompanying drawings, in which:

FIG. 1 and FIG. 2 are schematic diagrams illustrating a common venetian blind with an upper rail exposed, and another common venetian blind with a hidden upper rail under a cover plate, respectively;

FIG. 3 is a schematic diagram illustrating a side view of a mechanical assembly according to an embodiment of the present invention, wherein a cover plate and an upper rail are assembled through a fixing device;

FIG. 4A is a schematic diagram illustrating a perspective view of a fixing device according to an embodiment of the present invention;

FIG. 4B is a schematic diagram illustrating a cross-sectional view, which exemplifies a coupling member of the fixing device shown in FIG. 4A;

FIG. 5A is a schematic diagram illustrating a side view of a fixing device according to another embodiment of the present invention;

FIG. 5B is a schematic diagram illustrating a perspective view of the fixing device shown in FIG. 5A, wherein the fixing device has a pivot mechanism;

FIG. 6 is a schematic diagram illustrating a side view of a mechanical assembly, which includes the fixing device shown in FIG. 5A and FIG. 5B;

FIG. 7 is a schematic diagram illustrating a fixing device according to a further embodiment of the present invention;

FIG. 8A-8E are schematic diagrams illustrating an assembling process of a mechanical assembly according to an embodiment of the present invention; and

FIGS. 9A-9C are schematic diagrams illustrating a coupling member of a fixing device according to an embodiment of the present invention.

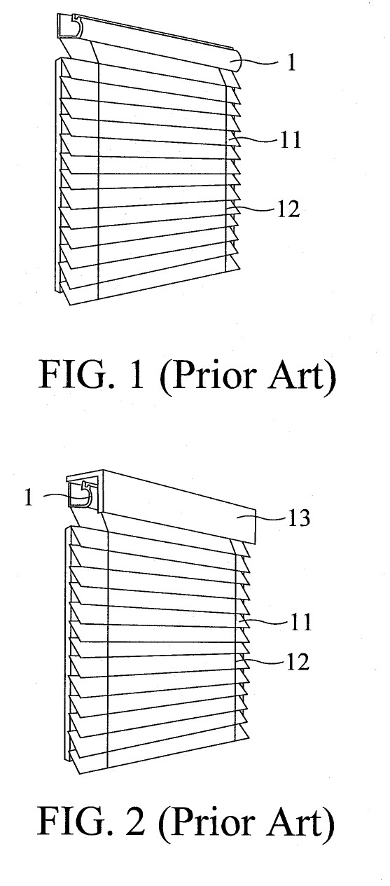

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

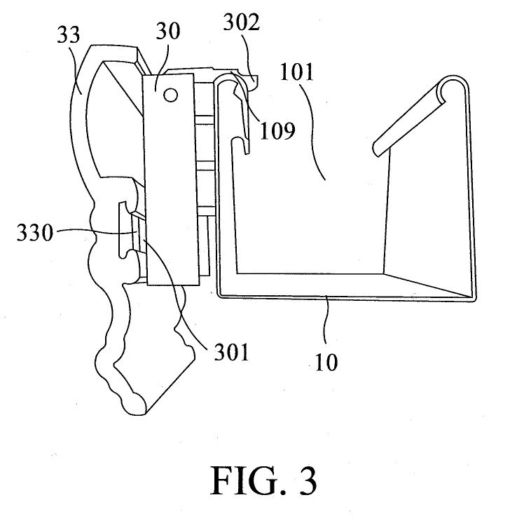

A mechanical assembly according to the present invention includes a steady body, a detachable member and a fixing device, wherein the fixing device includes a first coupling member to couple to the steady body and a second coupling member to couple to the detachable member, and at least one of the first and second coupling members are detachable from the object that it is coupled to, thereby allowing the detachable member to be mounted to the steady body in a detachable manner. Giving an application to a venetian blind as partially illustrated in FIG. 3 as an example, the steady body 10 can be an upper rail of the venetian blind, which is generally mounted onto a wall or a window frame (not shown), the detachable member 33 can be a cover plate for covering the upper rail 10 for decoration and/or any other possible purposes. The fixing device 30 includes an engagement projection 301 serving as the first coupling member and a hook 302 serving as the second coupling member. The upper rail 10 has a cavity 101. The space provided in the cavity 101 is mainly used to accommodate lifting-associated devices (not shown). The cover plate 33 has an engagement track 330 on a back surface thereof for receiving the engagement projection 301 of the fixing device 30, and allows the engagement projection 301 to be movably accommodated therein. The hook 302 of the fixing device 30 detachably hangs on a top edge 109 of a wall of the upper rail 10. In this way, the cover plate 33, the fixing device 30 and the upper rail 10 can be assembled and disassembled easily.

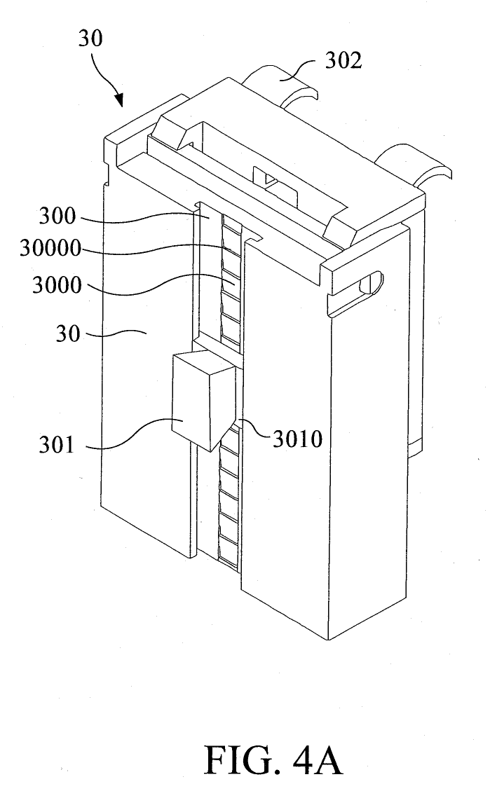

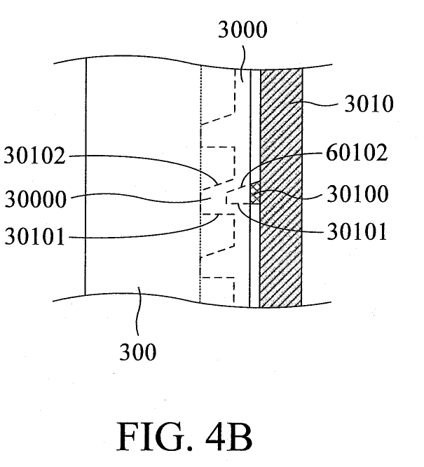

In addition to easy attachment and detachment, it is preferred that the relative position of the cover plate 33 and the upper rail 10 can be adjusted for better alignment. In an embodiment according to the present invention, the relative level of the cover plate 33 and the upper rail 10 can be adjusted by way of the fixing device 30. Referring to FIG. 4A and FIG. 4B, the fixing device 30 includes a main body 300, the engagement projection 301 and the hook 302, as mentioned above, and a base 3010 of the engagement projection 301 is fitted into a slide groove 3000 of the main body 300. The bottom of the slide groove 3000 has a plurality of parallelly extending wedge grooves 30000, each having a shape conforming to the shape of at least one flexible wedge hump 30100 protruding from the base 3010. Each of them substantially has a horizontal surface 30101 and a slope 30102 oppositely disposed. After the wedge bump 30100 is inserted into and engaged with one of the extending wedge grooves, e.g. the wedge groove 30000, the wedge bump 30100 can be easily moved upwards along the slope 30102 to detach from the wedge groove 30000, and then enters next wedge groove 30000. On the contrary, the wedge bump 30100 would be stopped from escaping from the wedge groove 30000 by the horizontal surface 30101, so the downward movement of the wedge bump 30100 is limited. On the other hand, the cover plate 33 fixed onto the fixing device 30 can be moved in the opposite direction i.e., downwards, while the upward movement of the cover plate 33 is limited. The number of the engagement projections 301 shown in the figure is one, but it may be increased to a multiple number if required. For example, the adjustment by the fixing device 30 can still work even if one of the engagement projections is broken.

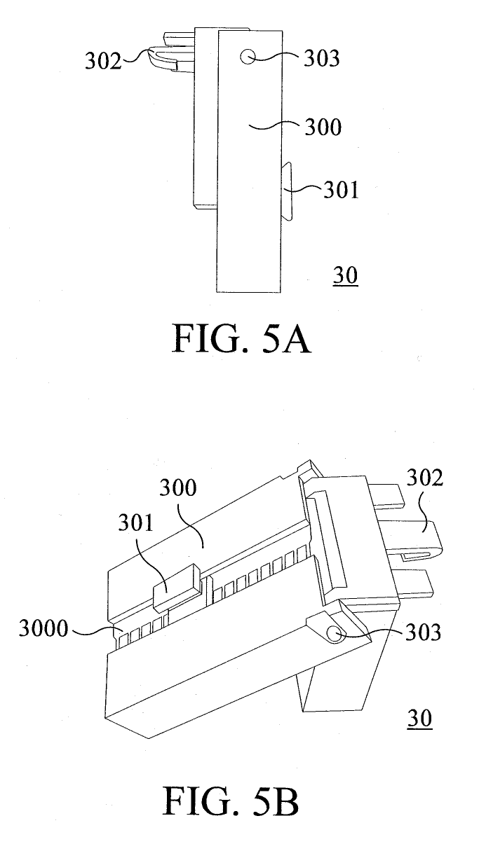

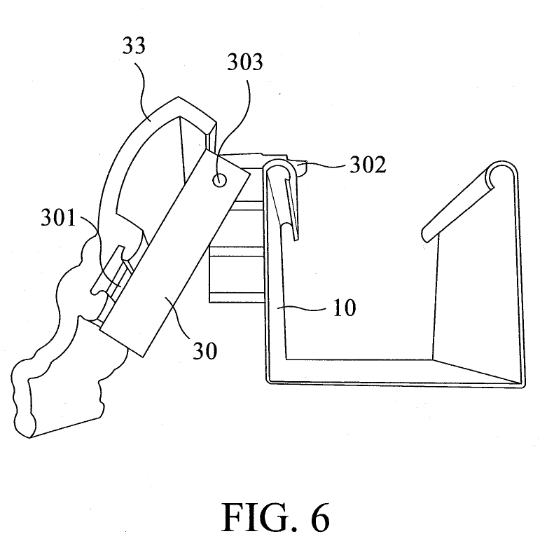

FIG. 5A and FIG. 5B schematically illustrate a fixing device 30 according to another embodiment of the present invention. The fixing device 30 further includes a pivot mechanism 303. The hook 302 and the main body 300 of the fixing device are connected through a pivot mechanism 303, which allows relative rotation between the hook 302 and the main body 300 of the fixing device to be conducted within a specific angular range. With the pivot mechanism 303, the cover plate 33 can be pivotally lifted to expose the upper rail 10. FIG. 6 schematically shows a side view of an assembly of the cover plate 33 with the upper rail 10 via the fixing device 30 according to an embodiment of the present invention, wherein the fixing device 30 may be attached to the cover plate 33 with the engagement projection 301 as exemplified above with reference to FIG. 4A and 4B, and attached to the upper rail 10 with the hook 302 as exemplified above with reference to FIG. 6, and the pivot mechanism 303 facilitates cleaning, repairing and/or any other suitable purpose.

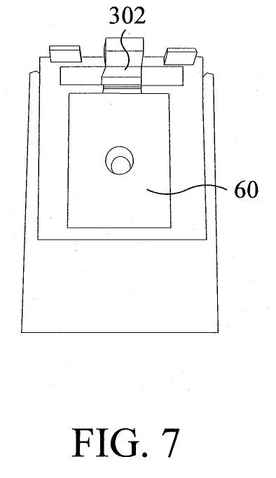

FIG. 7 schematically illustrates a back view of a fixing device 30, where the hook 302 is disposed for coupling to the upper rail 10, according to a further embodiment of the present invention. In this embodiment, the fixing device 30 further includes a magnet 60 integrated with and disposed under the hook 302. When the fixing device 30 is attached onto the surface of the upper rail 10, which is generally made of a metallic material, e.g. iron, by way of the hook 302, the magnet 60 provides a magnetic force to achieve a relatively stable fit to the upper rail 10. It is understood that if the magnet 60 provides a magnetic force strong enough to retain the fixing device 30 as well as the cover plate 33 on the upper rail 10, the hook 302 may be omitted or simply serve as a stopper, e.g. with a flat-plate configuration. The stopper 302 also functions for positioning the fixing device 30 as well as the cover plate 33 relative to the upper rail 10.

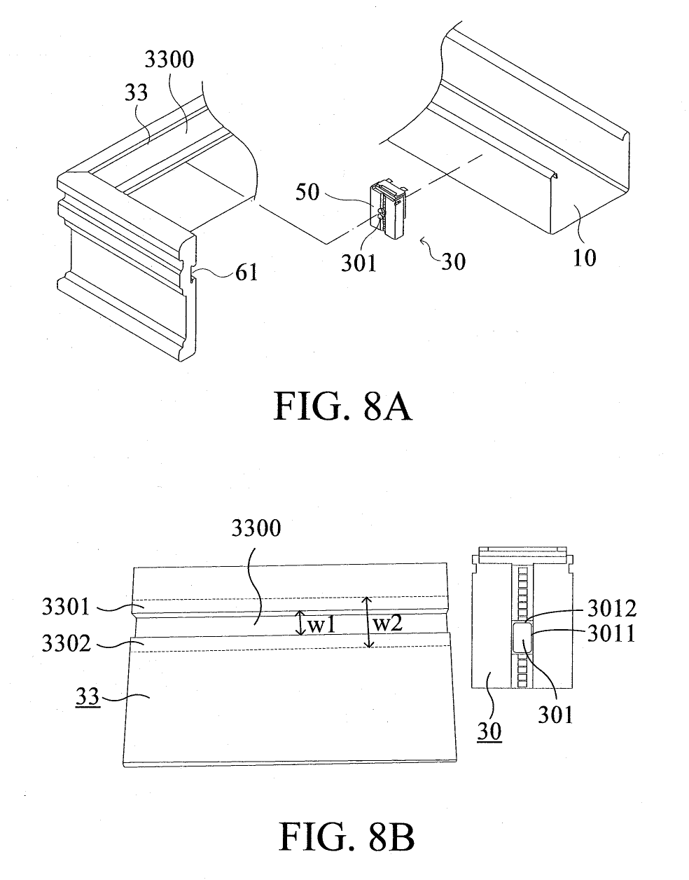

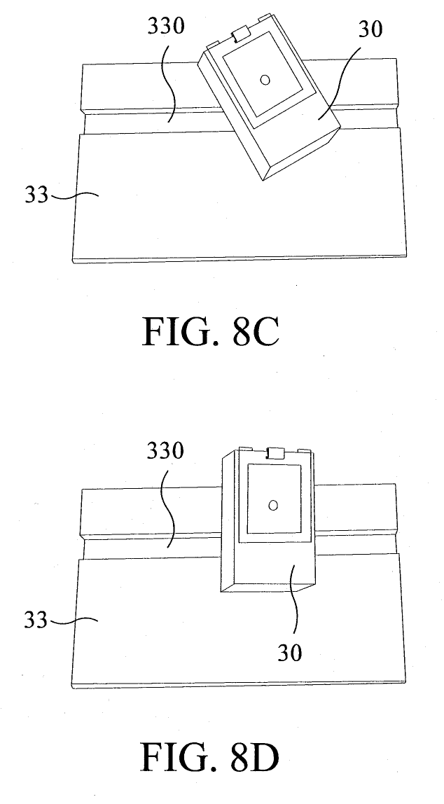

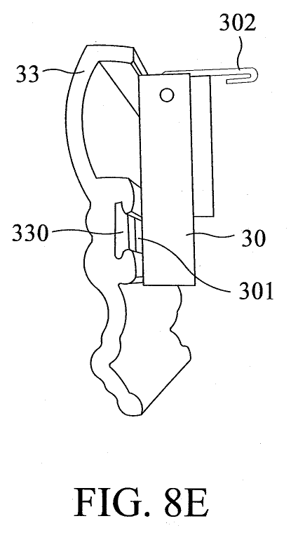

Please refer to FIGS. 8A, 8B, 8C, 8D and 8E, which are schematic diagrams illustrating the engagement of the fixing device 30 with the engagement track 330 of the cover plate 33 by way of the engagement projection 301 according to still another embodiment of the present invention, in order to mount the cover plate 33 onto the upper rail 10. As shown in FIG. 8A, the cover plate 33 is generally a U-shaped in order to well cover three surfaces of the upper rail 10. In this case, the fixing device 30 needs to be directly inserted into the engagement track 330 from a front opening 3300 of the track 330 instead of sliding into the track 330 from a lateral surface 61. Therefore, in this embodiment, the engagement projection 301 has a longer side 3011 having a length greater than an open width W1 of the engagement track 330, and a shorter side 3012 having a length smaller than the open width W1 of the engagement track 330, as illustrated in FIG. 8B. Furthermore, the engagement track 330 has an upper groove 3301 and a lower groove 3302 so as to result in an accommodating width W2 greater than the open width W1 and the longer side of the engagement projection 301. The engagement projection 301 is first inserted into the engagement track 330 of the cover plate 33 with the shorter side 3012 of the engagement projection 301, and then the fixing device 30 is gradually turned to a specified angle, e.g. 90 degrees, as shown in FIGS. 8C-8D, which allows the longer side 3011 of the engagement projection 301 to enter the upper groove 3301 and the lower groove 3302 and be stopped from escaping from the engagement track 330. Afterwards, the relative level between the fixing device 30 and the cover plate 33 can be adjusted in a manner similar to that illustrated with reference to FIG. 4A and 4B. For example, the level of the fixing device 30 can be adjusted to be substantially aligned with the top of the cover plate 33, as shown in FIG. 8E.

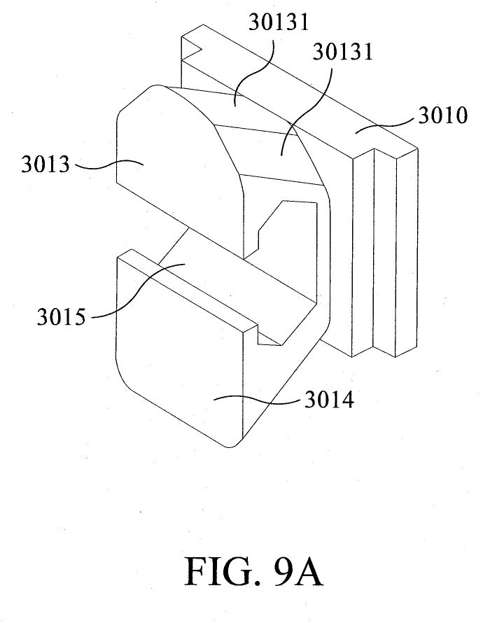

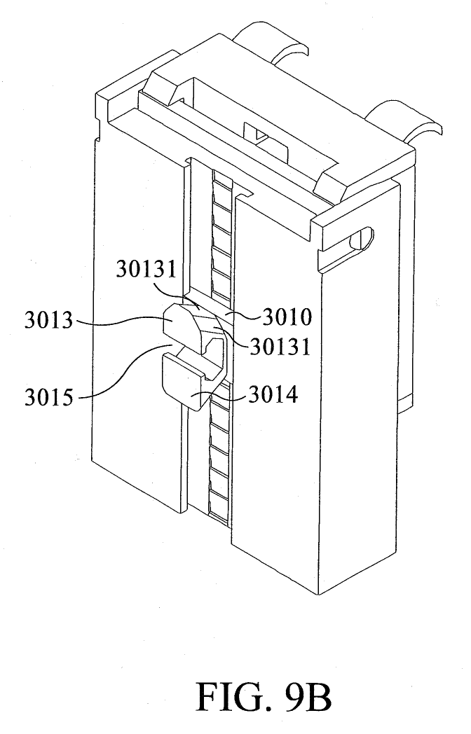

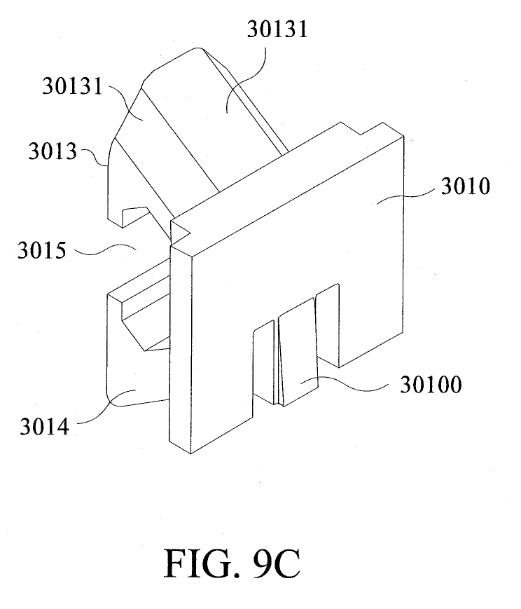

In an alternative embodiment, the engagement projection 301 includes two free ends 3013 and 3014 spaced from each other with a slot 3015, as exemplified in FIG. 9A. The presence of the slot 3015 makes the two free ends transformable to enter the engagement track 330 from the front opening 3300 and restorable to be stuck in the upper groove 3301 and the lower groove 3302 to be stopped from escaping from the engagement track 330.

Preferably, the configuration of the engagement projection 301 of the fixing device is particularly designed according to the present invention to improve the assembling and operational efficiency. As described above with reference to FIG. 4A and FIG. 4B, the wedge bump 30100 can be easily moved in the wedge groove 30001 in one direction, but hardly moved in an opposite direction, after the engagement projection 301 is mounted to the engagement track 330. Therefore, in this embodiment, configurations of two the two free ends 3013 and 3014 of the engagement projection 301 are made different to specify an operational direction. FIG. 9B illustrates one of the examples, wherein the upper end 3013 serves as a directional indicator, along which the engagement projection 301 can be moved, In a specific embodiment, the upper end 3013 has a plurality of continuous tangent surfaces 30131, which facilitates smooth but tactile rotation of the engagement projection 301 in the engagement track 330, if necessary. Furthermore, an example of the wedge bump 30100 is schematically shown in FIG. 9C.

Since the engagement projection 301 is a small part which might be put into mouth by young kids if separated from the main body 300, it is preferred that the engagement projection 301 is added with a bitter flavor such as denatonium benzoate, or any other suitable irritating flavor, to avoid from being played and swallowed by young kids.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mechanical assembly, comprising:
a steady body;
a detachable member mounted onto the steady body; and
a fixing device including a main body, a first coupling member disposed on the main body for coupling to the steady body and a second coupling member disposed on the main body for coupling to the detachable member, at least one of the first and second coupling members being detachable from the stead body and/or the detachable member so as to have the detachable member detachable from the steady body,
wherein the second coupling member includes an engagement projection, which includes a base fitted into a slide groove of the main body, and a wedge bump protruding from the base and inserted into and engaged with a specified one of a plurality of wedge grooves in the slide groove, and the wedge bump is movable from the specified wedge groove to next wedge groove along a first direction in response to a force for adjusting a relative position of the detachable member to the steady body, and
wherein the specified wedge groove is configured to have the wedge bump movable therein in the first direction but stop the wedge bump from moving therein in a second direction opposite to the first direction, and a first end and a second end of the engagement projection are different in configuration in order to specify the first direction.

2. The mechanical assembly according to claim 1, wherein the stead body is an upper rail of a venetian blind, and the detachable member is a cover plate of the venetian blind.

3. The mechanical assembly according to claim 2, wherein the first coupling member includes a hook that hangs on a top edge of the upper rail.

4. The mechanical assembly according to claim 2, wherein the first coupling member includes a magnet that is attached onto the upper rail.

5. The mechanical assembly according to claim 3, wherein the first coupling member further includes a stopper above the magnet for positioning the fixing device relative to the upper rail.

6. The mechanical assembly according to claim 2, wherein the second coupling member includes the engagement projection, the cover plate has an engagement track on a back surface thereof, and the engagement track includes an upper groove and a lower groove at opposite sides of an opening of the engagement track so as to result in an accommodating space for accommodating the engagement projection therein.

7. The mechanical assembly according to claim 6, wherein the engagement projection has a longer side having a length greater than a width of the opening of the engagement track, and a shorter side having a length smaller than the width of the opening of the engagement track, and the engagement track has an upper groove and a lower groove so as to result in a width of the accommodating space greater than the width of the opening and the length of the longer side of the engagement projection, thereby allowing the engagement projection to be inserted into the engagement track with the shorter side, and allowing the longer side to enter the upper groove and the lower groove and stopped from escaping from the engagement track after turning the engagement projection.

8. The mechanical assembly according to claim 6, wherein the engagement projection includes two free ends which are different in shapes and spaced from each other with a slot so that the two free ends transformable to enter the engagement track from the opening and restorable to be stuck in the upper groove and the lower groove to be stopped from escaping from the engagement track.

9. The mechanical assembly according to claim 8, wherein one of the two ends of the engagement projection has a plurality of continuous tangent surfaces.

10. The mechanical assembly according to claim 1, wherein a shape of the wedge bump conforms to a shape of the specified wedge groove.

11. The mechanical assembly according to claim 1, wherein the engagement projection is added with an irritating flavor.

12. The mechanical assembly according to claim 1, wherein the irritating flavor is a bitter flavor of denatonium benzoate.

13. A mechanical assembly, comprising:
a steady body;
a detachable member mounted onto the steady body; and
a fixing device including a main body, a first coupling member disposed on the main body for coupling to the steady body and a second coupling member disposed on the main body for coupling to the detachable member, at least one of the first and second coupling members being detachable from the stead body and/or the detachable member so as to have the detachable member detachable from the steady body,
wherein the second coupling member includes an engagement projection, which includes a base fitted into and slidable inside a slide groove, which is disposed on a surface of the main body facing the detachable member, and a wedge bump protruding from the base and inserted into and engaged with a specified one of a plurality of wedge grooves in the slide groove, and the wedge hump is movable from the specified wedge groove into next wedge groove along a first direction in response to a force for adjusting a relative position of the detachable member to the steady body, and
wherein the specified wedge groove is configured to have the wedge bump movable therein in the first direction and stop the wedge bump from moving therein in a second direction opposite to the first direction.

14. A fixing device for detachably mounting a cover plate to an upper rail for assembling a venetian blind, the fixing device comprising:
a main body;
a first coupling member disposed on the main body for coupling to the upper rail;
a second coupling member disposed on the main body for coupling to the cover plate,
wherein at least one of the first and second coupling members is detachable from the upper rail and/or the cover plate so as to have the cover plate detachable from the upper rail,
wherein the second coupling member includes an engagement projection, which includes a base fitted into and slidable inside a slide groove, which is disposed on a surface of the main body facing the cover plate, and a wedge bump protruding from the base and inserted into and engaged with a specified one of a plurality of wedge grooves in the slide groove, and the wedge bump is movable from the specified wedge groove into next wedge groove along a first direction in response to a force for adjusting a relative position of the cover plate to the upper rail, and
wherein the specified wedge groove has a slope wall which facilitates the wedge bump to move in the first direction and a that wall which stops the wedge bump from moving in a second direction opposite to the first direction, and a first end and a second end of the engagement projection are different in configuration in order to specify the first direction.

15. The fixing device according to claim 14, wherein the first coupling member includes a hook that hangs on a top edge of the upper rail.

16. The fixing device according to claim 14, wherein the first coupling member includes a magnet that is attached onto the upper rail.

17. The fixing device according to claim 14, wherein the second coupling member includes the engagement projection, the cover plate has an engagement track on a back surface thereof, and the engagement track includes an upper groove and a lower groove at opposite sides of an opening of the engagement track so as to result in an accommodating space for accommodating the engagement projection therein.

18. The fixing device according to claim 17, wherein the engagement projection has a longer side having a length greater than a width of the opening of the engagement track, and a shorter side having a length smaller than the width of the opening of the engagement track, and the engagement track has an upper groove and a lower groove so as to result in a width of the accommodating space greater than the width of the opening and the length of the longer side of the engagement projection, thereby allowing the engagement projection to be inserted into the engagement track with the shorter side, and allowing the longer side to enter the upper groove and the lower groove and stopped from escaping from the engagement track after turning the engagement projection.

19. The fixing device according to claim 17, wherein the engagement projection includes two free ends which are different in shapes and spaced from each other with a slot so that the two free ends transformable to enter the engagement track from the opening and restorable to be stuck in the upper groove and the lower groove to be stopped from escaping from the engagement track.

20. The fixing device according to claim 14, wherein the engagement projection is added with an irritating flavor.
